(19) United States
(12) Patent Application Publication
(10) Pub. No.: US 2006/0109880 A1
(43) Pub. Date: May 25, 2006

(54) Wafer laser crystal

(76) Inventors: Daniel Rytz, Herborn (DE); Klaus Dupre, Idar-Oberstein (DE); Lothar Ackermann, Idar-Oberstein (DE)

Correspondence Address: John F. McNulty;Paul & Paul, 2900 Two Thousand Market Street, Philadelphia, PA, 19103, US

(21) Appl. No.: 11/286,506

(22) Filed: Nov. 23, 2005

(30) Foreign Application Priority Data
Nov. 25, 2004 (DE) 10 2004 056 902.9

(51) Int. Cl. H01S 3/14

(52) U.S. Cl. 372/39

(57) ABSTRACT

The present invention concerns a laser with a laser crystal in wafer form. In order to provide a laser apparatus with laser materials in wafer form which are improved over the state of the art, and a process for the production of improved laser materials in wafer form for such laser apparatuses, it is proposed in accordance with the invention that the laser crystal is of the chemical composition M^{I}R^{III}(WO₄)₂, wherein M¹ stands for an alkali metal, R^{III} stands for a lanthanide and X stands for a laser-active doping substance.

The present invention concerns a laser having a laser crystal in wafer form and a process for the production of a laser crystal in wafer form.

Laser light, that is to say light which is spatially and temporally coherent has found uses in the meantime in many fields. Thus laser technology is used for example in the areas of medicine, production technology, measurement and testing procedures and environmental protection. The demands on laser technology in those areas are constantly rising and there is a great need for more powerful and more efficient lasers which operate reliably, afford a high level of beam quality and which are to be operated with the greatest possible freedom from trouble and maintenance.

Inter alia solid state, gas and liquid lasers as well as lasers using semiconductor materials can be used for the production of laser light.

In regard to solid state lasers, besides the traditional rod lasers, wafer lasers have now been known for some time. Wafer lasers involve using a laser crystal in wafer form. The layer thickness of the laser crystal is generally in a range of some tenths of a millimetre to some millimetres and is thus markedly reduced in comparison with the layer thickness of laser crystals in rod form of conventional rod lasers (d=about 10 cm). The diameter of the laser crystals in wafer form is generally about 10 mm.

The concept of the wafer laser is based on a laser medium in wafer form, which is mounted on and connected to a cooling element—which is generally liquid-cooled. The rear side of the laser wafer is cooled at one side by the cooling element. The area cooling effect at the rear side of the very thin laser crystal gives rise to temperature gradients predominantly in the direction of the laser beam and therefore have scarcely any influence on the quality of the laser beam. That is in contrast to the conventional rod laser in which the thermally induced changes have a considerably more severe adverse influence on the properties of the laser medium, with the laser beam being correspondingly more severely optically distorted. Thermal lens effects and thermally induced birefringence are also comparatively reduced in the wafer laser.

On the side connected to the cooling element the laser medium in wafer form is frequently provided with a reflective coating. For the purposes of connecting the laser wafer to the cooling element, the arrangement often has a soft, thermally conductive intermediate layer which can cushion thermal deformations of the laser wafer which occur in the pumping operation or in the production of laser light and can absorb heat from the laser wafer and transmit it to the cooling element.

Various chemical compositions have already been tested as materials for wafer lasers. The most widespread is ytterbium-doped yttrium-aluminium-gamet (Yb:YAG) of the chemical formula Yb:Y₃Al₅O₁₂. In that material the yttrium-aluminium-garnet represents the neutral basic lattice of the laser material which is not involved in the actual laser process. The constituents (atoms, ions and molecules) which are crucial for laser light emission, the so-called laser-active substances, are incorporated into the basic lattice of a laser material. In the case of the Yb:YAG the laser-active substance is the ytterbium.

Yb:YAG has good mechanical properties which allow the commercial production of wafers of diameters in the range of 5 to 25 mm and of wafer thicknesses of about 300 μm. It will be noted however that the laser-specific properties of the Yb:YAG are markedly surpassed by other materials. For example ytterbium-doped potassium-yttrium-tungstate (Yb:KYW) of the chemical formula Yb:KY(WO₄)₂ is known for its high absorption and emission cross-sections. However production of the preferably very thin laser wafers from the laser material Yb:KYW is in practice extremely difficult as that material is of relatively low hardness and has only little mechanical strength.

The following problems frequently occur in operation of laser apparatuses with conventional laser materials with good laser-specific properties in wafer form. Thus the thermally induced deformation phenomena referred to in the opening part of this specification, even in the case of laser wafers mounted on soft intermediate layers, not infrequently result in flaws or fractures in the crystals. The mounting of crystal wafers on a cooling liquid film is also critical and often results in destruction of the crystal, particularly with very thin wafers.

In laser technology therefore there is a need for laser apparatuses with laser materials in wafer form, which enjoy very good mechanical properties like the widespread Yb:YAG and which at the same time have markedly better laser-specific properties in comparison with Yb:YAG. In particular it is desirable to provide laser materials having high absorption and emission cross-sections, from which wafers which are as thin as possible can be produced, which can be used in laser apparatuses, which can be permanently employed therein and which are possibly also interchangeable, without fracturing or breaking.

Consequently the object of the present invention is to provide a laser apparatus with laser materials in wafer form, which are improved over the state of the art, and a process for the production of improved laser materials in wafer form for such laser apparatuses.

In accordance with the invention that object is attained by the use of a laser crystal of the chemical composition M^{I}R^{III}X(WO₄)₂, wherein M^{I} stands for an alkali metal, R^{III} stands for a lanthanide, and X stands for laser-active ions with which the material is doped, and wherein the material is provided in the form of a wafer.

The basic lattice structure of that material is M^{I}R^{III}X(WO₄)₂, wherein R^{III} stands for at least one element from the group of lanthanides which includes the elements lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu). That basic lattice is doped with active laser ions, the active laser ions preferably being selected from Yb³⁺, Nd³⁺,Er³⁺, Ho³⁺, Tm³⁺and Pr³⁺.

In preferred embodiments the alkali metal (M^{I}) is selected from lithium, sodium, rubidium and caesium.

In a particularly preferred embodiment M^{I} is sodium (Na).

Preferably the laser material used in apparatuses according to the invention is congruent-melting. The term congruent-melting material is used here to denote a material comprising a compound which does not already dissociate into its components below its melting point but breaks down into its components only at the moment of melting, solid and liquid phases involving the same equilibrium composition.

By means of a number of tests it was possible to demonstrate that the tungstate material provided in the apparatus according to the invention not only has very good laser- specific properties but also excellent mechanical properties which make it possible to also use very thin laser media which have sufficient mechanical strength to be suitable for use for the usual applications as a wafer laser. This means that processing of the material of the aforementioned composition to provide wafers of very small thickness is possible, in which respect wafers of very small thickness can be easily cut out from a crystal body comprising one of the claimed materials and then polished without the material being damaged in that procedure. Thus, when polishing such wafers, markedly fewer edge breakages occur than when polishing conventional materials and the anisotropic properties of the polished surfaces are very much less pronounced than for example with Yb:KYW.

In preferred embodiments of the invention the laser material wafer is preferably of a thickness of <3 mm. In further preferred embodiments the thickness of the laser wafer is between 0.5 μm and 1 mm and in the case of special embodiments of this invention it is in a range of between 5 and 250 μm.

The term wafer is used here to denote a body whose mean thickness is a multiple smaller than its length and width. In that respect the external shape of the body is basically irrelevant. Thus that definition embraces bodies having a triangular, rectangular, polygonal or round base surface and also such bodies whose thickness is not constant over the entire body. In a narrower sense the term wafer is used herein to denote a body corresponding to the above-mentioned definition with a symmetrical base surface, wherein the surfaces of the top side and the underside respectively of the wafer are planar to slightly curved.

Preferably the crystal material according to the invention is cut into circular to oval wafers. In the case of circular wafers, it is particularly preferred if the ratio of the diameter of the wafer D to the thickness of the wafer L is greater than 4.9. In that respect it is particularly advantageous if the diameter of the wafer D is in the range of between 1 and 51 mm, preferably in the range of between 2 and 30 mm and particularly preferably in the range of between 3 and 20 mm.

In order to obtain surfaces which are as flat as possible on the laser wafer, it is particularly preferred if at least a part of the surface of the wafer is polished. Further preferred embodiments are characterised in that the surface of the wafer is at least partially de-reflected or bloomed or provided with a reflecting coating. The surface of the wafer is preferably de-reflected on the side of the wafer, which is in opposite relationship to the cooling element. On the side towards the cooling element the laser wafer is preferably provided with a coating which is highly reflective both for the pump wavelength and also for the emitted laser wavelength.

In a special embodiment of the present invention the lanthanide in the above- mentioned chemical composition is gadolinium (Gd). Preferably those materials are doped with the active laser ions Yb³⁺or Nd³⁺.

A particularly preferred embodiment of the laser according to the invention uses a material of the general formula NaGd₁₋ₓYbₓ(WO₄)₂, wherein x is preferably of a value of between 0 and 1. A value for x between 0.01 and 0.4 is particularly preferred and a value for x of between 0.05 and 0.25 is especially preferred.

Another preferred embodiment of the laser according to the invention uses a material with a Nd³⁺doping and is described by the general formula NaGd₁₋Ndₓ(WO₄)₂, wherein x is preferably of a value of between 0 and 0.2. With that material, a value for x of between 0.001 and 0.1 is particularly preferred and a value for x of between 0.005 and 0.05 is especially preferred.

In a further specific embodiment of the invention the laser material contains lanthanum (La) as the lanthanide. Preferably those materials involve a doping with ytterbium (Yb³⁺) or neodymium (Nd³⁺). A particularly preferred embodiment of that material is doped with ytterbium and is described by the general formula NaLa₁₋ₓYbₓ(WO₄)₂, wherein x is preferably of a value of between 0 and 1. It is particularly preferred for the value of x to be between 0.01 and 0.4 and a value for x which is especially preferred is between 0.05 and 0.25.

A further preferred material of the aforementioned kind involves a doping with neodymium and its general formula is NaLa₁₋ₓNdₓ(WO₄)₂. In this embodiment the value for x is preferably between 0 and 0.2 and is particularly preferably between 0.001 and 0.1. A value for x of between 0.005 and 0.05 is especially preferred.

It will be appreciated that it is also possible to use liquid crystals which are segmented or assembled by means of bonding. In that way it is possible to use liquid crystals with undoped ends or end layers. When using such composite laser materials which comprise a doped segment of the above-mentioned chemical composition (e.g.: NaGd₁₋ₓNdₓ(WO₄)₂) and an undoped segment on the basis of the corresponding chemical composition (for example: NaGd(WO₄)₂) ground state absorption and thermal lens effects can be produced. In addition the coatings remain at the undoped ends at low temperature and are therefore not exposed to any troublesome thermally induced stresses. The scatter loss induced by the interface between doped and undoped segments is generally negligible.

Such composite crystals can further increase the efficiency of thin wafer lasers in many cases. The enhanced mechanical stability of materials of the chemical compositions described herein considerably expands the possible options in terms of production of the above-mentioned bonded or segmented laser materials.

In order to obtain the tungstate material provided in the laser apparatus according to the invention in crystal form, preferably in the form of a single crystal, there is also provided a process for the production of such a crystalline material.

To produce that material, in the process according to the invention, a crystal is grown from a melt of the chemical composition M^{I}R^{III}X(WO₄)₂ in accordance with the Czochralski process, wherein M^{I} is an alkali metal, preferably lithium, sodium, rubidium or caesium, particularly preferably sodium, R^{III} is at least one lanthanide and X are laser-active ions. Preferably the lanthanide is gadolinium (Gd) or lanthanum (La). Preferably ytterbium (Yb) or neodymium (Nd) are used for the doping operation as laser-active ions. In these preferred embodiments of the process according to the invention the growth temperature is about 1,200 to 1,300° C.

Following growth of the crystal, which is generally concluded after about 14 days, the crystal axes (in the case of Yb-doped NaGd(WO)₄) of the grown crystal are determined, and then a rod of the desired diameter is bored out of the grown crystal, corresponding to the crystal axes. Wafers of the desired layer thickness are then cut from that crystal rod and the resulting wafers are polished.

In a particularly preferred embodiment of the laser according to the invention the laser material is optically pumped with light in a wavelength range of 390 to 2,100 nm. In that case preferably laser emissions in the wavelength range of between 400 and 3,000 nm are produced.

For the purposes of the original disclosure it is pointed out that all features as can be deduced by a man skilled in the art from the present description and the claims, even if they are described specifically only in conjunction with certain further features, can be combined both individually and also in any combinations with others of the features or groups of features disclosed herein, insofar as that has not been expressly excluded or technical factors make such combinations impossible or meaningless. A comprehensive and explicit representation of all conceivable combinations of features is not set forth here only for the sake of brevity and readability of the description.

The following examples may be considered by way of example of the possible combinations arising herefrom, such examples also describing additional features and further embodiments of the present invention.

### EXAMPLE 1

Growth of NaGd_{1-X}Yb_{X}(WO₄)₂ crystals with x=0.01−1 from a melt of the same composition in accordance with the Czochralski process.

The growth temperature is approximately 1250° C. The melt is prepared in a crucible of iridium or platinum, in which respect platinum crucibles have the advantage that operation can be conducted in the presence of ambient air. A seed crystal is introduced into the liquid melt and the temperature is so adjusted that the seed and the melt are in equilibrium. The crystal is then drawn slowly out of the melt. The diameter of the crystal can be controlled by way of a weighing device. Crystals of a diameter of up to 40 mm and a length of up to 80 mm can be produced in 7 days. After the growth procedure those crystals are cooled to 20° C. in about 2 days. They are colourless and can be subjected to further processing directly.

The crystal axes are determined prior to the first step of further processing. That can be effected by means of optical and X-ray-photographic processes. The desired orientations for wafers are perpendicular to the c- or a-axes. After the operation of boring out a rod with the desired axis and of the desired diameter the wafers are sawn off to give a desired thickness (for example 0.35 mm). A set of those wafers is ground and polished with a double-sided polishing process. In that case the final dimension is achieved with a desired thickness (for example 130 μm) and the desired planarity (for example λ/8 with an emission wavelength of λ=663 nm). If desired special polishes can be implemented on individual wafers in order to produce surfaces with an extremely low defect density.

Particularly good mechanical properties could be observed for x approximately equal to 0.05.

### EXAMPLE 2

Growth of NaGd_{1-X}Ndₓ(WO₄)₂ crystals with x=0.001−0.2 from a melt of the same composition in accordance with the Czochralski process, as described in detail for example 1).

### EXAMPLE 3

Growth of NaLa₁₋ₓYbₓ(WO₄)₂ crystals with x=0.01−1 from a melt of the same composition in accordance with the Czochralski process, as described in detail for example 1).

### EXAMPLE 4

Growth of NaLa₁₋ₓNdₓ(WO₄)₂ crystals with x=0.001−0.2 from a melt of the same composition in accordance with the Czochralski process, as described in detail for example 1).

1. A laser with a laser crystal in wafer form, characterised in that the laser crystal is of the chemical composition M^{I}R^{III}X(W0₄)₂, wherein M¹ stands for an alkali metal, R^{III} stands for a lanthanide and X stands for a laser-active doping substance.

2. A laser according to claim 1 characterised in that M^{I} is either lithium, sodium, rubidium or caesium.

3. A laser according to claim 1 or claim 2 characterised in that X is either Yb, Nd, Er, Ho, Tm or Pr.

4. A laser according to one of claims 1 to 2 characterised in that the wafer is of a thickness L of less than 3 mm.

5. A laser according to one of claims 1 to 2 characterised in that the ratio of the diameter D of the wafer to the thickness L of the wafer is greater than 4.9.

6. A laser according to one of claims 1 to 2 characterised in that the diameter D of the laser crystal wafer is in the range of between 1.0 and 51.0 mm.

7. A laser according to one of claims 1 to 2 characterised in that one side of the wafer is at least partially provided with a reflective coating.

8. A laser according to one of claims 1 to 2 characterised in that R^{III} stands for gadolinium (Gd), wherein X is Yb or Nd.

9. A laser according to claim 8 characterised in that the laser crystal is of the general formula NaGd_{1-X}Yb_{X}(W0₄)₂, wherein x is of a value of between 0 and 1.

10. A laser according to claim 8 characterised in that the laser crystal is of the general formula NaGd_{1-X}Ndₓ(W0₄)₂, wherein x is of a value of between 0 and 0.2.

11. A laser according to one of claims 1 to 2 characterised in that R^{III} stands for La; wherein X is Yb or Nd.

12. A laser according to claim 11 characterised in that the laser crystal is of the general formula NaLa₁₋ₓYbₓ(WO₄)₂, wherein x is of a value of between 0 and 1.

13. A laser according to claim 10 characterised in that the laser crystal is of the general formula NaLa₁₋ₓNdₓ(W0₄)₂, wherein x is of a value of between 0 and 0.2.

14. A laser according to one of the claims 1 to 2 characterised in that the laser crystal comprises at least two portions of different chemical compositions; wherein one portion is not doped with laser-active ions.

15. A laser according to one of claims 1 to 2 characterised in that there is provided a means for cooling one side of the laser crystal.

16. A laser according to one of claims 1 to 2 characterised in that there is provided a means for optically pumping the laser crystal with light of a wavelength in a wavelength range of from 390 to 2,100 nm.

17. A process for the production of a laser crystal in wafer form comprising the following steps:
i) growing a crystal out of a melt of the chemical composition M^{I}R^{III}X(WO₄)₂, wherein M^{I} stands for an alkali metal. R^{III} stands for a lanthanide, and X stands for a laser-active doping substance,
ii) determining the crystal axes of the grown crystal,
iii) boring out a rod from the grown crystal in the direction of a crystal axis, and
iv) cutting off wafers of desired thickness from the crystal rod.

18. A process according to claim 17 wherein at least parts of the surface of the wafers are polished.

19. A laser according to claim 4, characterized in that the wafer is of a thickness L of between 0.5 μm and 1 mm.

20. A laser according to claim 19, wherein L is of between 5 and 250 μm.

21. The laser according to claim 5, characterized in that the ratio of the diameter D of the wafer to the thickness L of the wafer is greater than 7.5.

22. A laser according to claim 6, characterized in that the diameter D of the laser crystal wafer is in the range of between 2 and 30 mm.

23. A laser according to claim 22, wherein D is between 3 and 20 mm.

24. A laser according to claim 9, wherein X is of a value of between 0.01 and 0.4.

25. A laser according to claim 24, wherein X is of a value of between 0.05 and 0.25.

26. A laser according to claim 10, wherein X is of a value of between 0.001 and 0.1.

27. A laser according to claim 26, wherein X is of a value of between 0.005 and 0.05.

28. A laser according to claim 12, wherein X is of a value of between 0.01 and 0.4.

29. A laser according to claim 28, wherein X is of a value of between 0.05 and 0.25.

30. A laser according to claim 13, wherein X is of a value of between 0.001 and 0.1.

31. A laser according to claim 30, wherein X is of a value of between 0.005 and 0.05.

32. A laser according to claim 2, wherein M′ is sodium.

33. The process of claim 17, wherein M′ stands for sodium; wherein R″′ stands for gadolinium; and wherein X stands for Yb.
